(19) United States
(12) Patent Application Publication
(10) Pub. No.: US 2020/0074497 A1
(43) Pub. Date: Mar. 5, 2020

(54) EVALUATING MEDIA CONTENT USING MONTE CARLO ATTRIBUTION

(71) Applicant: Free Stream Media Corporation d/b/a Samba TV, San Francisco, CA (US)

(72) Inventor: Joshua J. Miller, San Francisco, CA (US)

(21) Appl. No.: 16/117,613

(22) Filed: Aug. 30, 2018

(51) Int. Cl. G06Q 30/02; G06F 17/18

(52) U.S. Cl. CPC G06Q 30/0242; G06F 17/18; G06Q 30/0272; G06Q 30/0204

(57) ABSTRACT

Approaches provide for evaluating lift associated with supplemental content based on a Monte Carlo unexposed method. Users may be separated into groups of exposed users that have interacted with supplemental content and an unexposed group that has not interacted with the supplemental content. Activity of the users in the unexposed groups may be tracked over conversion windows that are obtained, at least in part, from conversion windows of the exposed users. Thereafter, conversion rates for the unexposed group may be determined within the same windows as those of the exposed group to determine the impact of the supplemental content.

### BACKGROUND

Consumers often receive various types of information while consuming media content, such as by watching television or movies, listening to music, or viewing digital media. The information may be interspersed throughout the content, such as via product placement, or may be presented during breaks in the content. Content providers attempt to target the information to certain demographics and often choose certain media content to deploy in campaigns. Unfortunately, the providers have difficulty anticipating the impact of their information. While a provider may notice a change, such as an increase in sales or clicks for advertisements (which may be referred to as conversions), the provider often does not know how much of the increase is the result of the campaign. As such, content providers may take a broad approach to deploying campaigns, which may be inefficient.

### BRIEF DESCRIPTION OF THE DRAWINGS

Various embodiments in accordance with the present disclosure will be described with reference to the drawings, in which:

FIG. 1A illustrates an example environment in which aspects of the various embodiments can be utilized;

FIG. 1B illustrates an example environment in which aspects of the various embodiments can be utilized;

FIG. 1C illustrates an example environment in which aspects of the various embodiments can be utilized;

FIG. 2 illustrates an example system for evaluating exposure events in accordance with various embodiments;

FIG. 3 illustrates an example diagram of conversion windows over a campaign in accordance with various embodiments;

FIG. 4 illustrates an example system for determining a Monte Carlo unexposed group in accordance with various embodiments;

FIG. 5 illustrates an example process for determining lift using Monte Carlo unexposed groups in accordance with various embodiments;

FIG. 6 illustrates an example process for determining a success of a supplemental content campaign in accordance with various embodiments;

FIG. 7 illustrates an example process for determining an average conversion rate in accordance with various embodiments; and

FIG. 8 illustrates an example system for displaying content, in accordance with various embodiments.

### DETAILED DESCRIPTION

Systems and methods in accordance with various embodiments of the present disclosure may overcome one or more of the aforementioned and other deficiencies experienced in conventional approaches to determining an effectiveness, or lift, associated with supplemental content, such as advertisements.

In various embodiments, user devices such as televisions, monitors, wearable devices, smartphones, tablets, handheld gaming devices, and the like may include display elements (e.g., display screens or projectors) for displaying consumer content. This content may be in the form of television shows, movies, live or recorded sporting events, video games, and the like. Content displayed on these devices may be interspersed with supplemental content, such as advertising. In various embodiments, the supplemental content may attempt to induce a user into purchasing an item, navigating to a website, watching other content, or the like. Content providers may attempt to target or otherwise direct their supplemental content, which may also be referred to as targeted content, to particular users or demographics. This may be accomplished by associating targeted content with particular media content. For example, content providers may receive information that a certain demographic, say individuals in the 40-60 age range, predominantly watch cable news networks. Accordingly, the content provider may direct targeted content toward that demographic via cable news networks, rather than children's shows that may not often be watched by that demographic. However, content providers may have trouble predicting the likelihood of success for targeted content or measuring the success of a previous roll out of targeted content. Accordingly, systems and methods of the present disclosure are directed toward comparing conversion rates for different attribution groups, which will be described below. The comparison may evaluate conversion rates between users exposed to supplemental content, users associated with a synthetic control group, and users that were not exposed to supplemental content (e.g., unexposed users). In various embodiments, comparisons between the conversion rates may provide information regarding the total lift associated with a supplemental content campaign by comparing effectiveness (e.g., conversions) across the different associated groups. The differences may be utilized to determine the impact of the supplemental content campaign, which may lead to improved strategies to more efficiently deploy resources.

In various embodiments, a user device may include an embedded chipset utilized to identify content being displayed on the user device, which may be referred to as Automatic Content Recognition (ACR). The chipset may be utilized to receive the content feed being transmitted to the user device, for example a live TV feed, a streaming media feed, or feed from a set top cable box. Furthermore, in various embodiments, the chipset may extract or otherwise identify certain frames from the media stream for later processing and recognition. Identification may be facilitated by using a fingerprint made up of a representation of features from the content. For example, software may identify and extract features and compress the characteristic components into a fingerprint thereby enabling unique identification. In various embodiments, a one-way hash may be utilized in the generation of the fingerprint. This fingerprint may then be compared with a database of content to facilitate recognition. This database may include feature vectors and/or machine learning techniques to facilitate robust, quick matching. The recognition of content may be performed by a remote server or by the user device itself if it has sufficient processing capability and access to a content database. It should be appreciated that multiple fingerprints may also be utilized in the identification process. ACR may further be utilized to identify targeted content associated with the other media content being consumed by the user. Accordingly, the timing of targeted content may be correlated with the associated content, thereby providing valuable information to content providers regarding which media content is consumed along with their targeted content.

While various embodiments include an embedded chipset for generating fingerprints and performing ACR, in other embodiments fingerprint generation and ACR may be performed without an embedded chipset. For example, fingerprint generation and ACR may be performed by a software application running on the user device. As another example, fingerprint generation and ACR may be performed utilizing an application that may include software code stored on a second user device. For example, if a user were watching content on a television the user may incorporate a second user device, such as a smartphone, to take an image or video of the screen or receive a portion of audio from the content. Thereafter, the image, video, or audio content may be utilized similarly as described above to identify the content displayed on the screen.

In various embodiments, users may be identified and divided into different groups based on their consumption of content, particularly their exposure to supplemental content. As used herein, exposure refers to a user seeing or otherwise experiencing supplemental content. It should be appreciated that exposure may be particularly defined based on the content provider or the type of supplemental content. For example, in various embodiments exposure may refer to a certain period of time that the supplemental content is viewed (e.g., 5 seconds, 10 seconds, 20 seconds, etc.). Additionally, in various embodiments, exposure may also be correlated to whether or not a user navigated away from the media content when the supplemental content was presented. By utilizing ACR as described above, the user's viewing habits and associated exposure may be determined, as well as which supplemental content the user was exposed to. Accordingly, once exposure has been confirmed, the user's browsing or buying habits may be monitored, for example on a second user device or devices that correspond with an IP address, in order to determine whether a conversion has occurred. As used herein, conversion may refer to navigation to a website, purchasing a product, viewing certain content, or the like, and may also include in-person store visits and purchases. Furthermore, conversion may be defined within a time period, such as within a week of viewing the supplemental content, a day, or the like. Additionally, conversion may be recorded with respect to a number of exposures to the supplemental content. That is, the number of times the user is exposed to the supplemental content may be tracked up to and until conversion.

Tracking conversion for users that are exposed to supplemental content may assist content providers to better direct or otherwise deploy their supplemental content. However, there are many users who may not have been exposed to the supplemental content, but who may nevertheless undergo a conversion event. These users may share one or more characteristics with the exposed users, such as demographic information, interests in particular types of content, or the like. As such, it is desirable to evaluate conversions for users that were not exposed to the supplemental content, but are similar to those that were exposed, to determine the effectiveness of the supplemental content, which may be referred to as lift. In various embodiments, users may be classified as unexposed. In other words, the users may not have viewed the supplemental content. However, these unexposed viewers may be classified by the likelihood of viewing the content or their potential exposure, which may be based at least in part on previous viewing history. A subset of the unexposed viewers may be ranked, based on the likelihood of their potential exposure, and thereafter a control group may be selected from the ranked list, which may be referred to as a synthetic control group. It should be appreciated that the control group may be any size or percentage relative to the ranked list.

In various embodiments, the control group may be used to perform synthetic exposure events based on the control group's viewership history. For example, a period of time may be specified to monitor for certain conversion events, such as navigating to a website. Thereafter, the conversion for the users may be monitored within a similar time period of the exposed group. The conversion rates may be compared between groups, for example compared to the exposed group, to determine the difference in conversion rates between the control group and the exposed group. It should be appreciated that the difference may be representative of the true lift that can be associated to the supplemental content. That is, a difference in conversion rates between the exposed group and the control group is more representative of the content provider's success than a difference in conversion rates between the exposed group and the general population. By evaluating the groups (e.g., exposed and control) under similar conditions (e.g., definition of conversion, time period, etc.) the effects of the supplemental content are effectively normalized to determine what type of impact, or lift, exposure to the supplemental content drives.

While the synthetic control groups may be effective at identifying conversions for a group that may be related to exposed groups, there still may be conversions associated with the remaining subset of the unexposed group (e.g., the unexposed group or groups not sorted into the control groups). Identifying an appropriate conversion window for this subset may be particularly challenging, because there is no event, such as exposure, to track the relevant period of time for a conversion. Moreover, arbitrarily selecting a conversion window, or setting a conversion window that extends the length of a supplemental content campaign, may inflate conversion rates. In other words, the subset of the unexposed group may not be normalized with respect to the exposed group and the synthetic control group, thereby potentially misrepresenting the results and not identifying the lift associated with the campaign. As will be described herein, in various embodiments, lift may be determined by evaluating a difference between the conversion rates for the exposed group and for the subset of the unexposed group (e.g., the remainder of the unexposed group not associated with the synthetic control group). As a result, the lift of the campaign may be determined by effectively removing those users that may have already had a propensity to convert to evaluate the impact on the general population.

In various embodiments, the subset of the unexposed group may be referred to as a Monte Carlo unexposed group (e.g., MCU). For instance, the MCU may be associated with Monte Carlo methods that sample a probability distribution over a group, such as a Markov chain. In various embodiments, conversion windows may be determined by selecting exposed households at random and setting conversion windows for the MCU to mirror the conversion windows for the exposed households. As a result, exposures corresponding to the exposed households (e.g., exposed group) may be used as exposure events for the unexposed households to effectively monitor conversions over the same period of time. By selecting many such exposed households, anomalous behavior may have a smaller impact on the calculated exposure rates for the MCU and an average conversion rate for the MCU may be determined. Accordingly, comparisons over similar periods of time may be established to evaluate the lift of a campaign.

In various embodiments, inadvertent or other exposures may be evaluated. For example, a user's browsing history may be tracked and the presence of additional exposures (which may be referred to as touches) may be recorded. Accordingly, users within the control group who receive exposure from other sources, such as digital media on a second screen, may be removed from the control group. Further, users that are subject to more touches may be removed or otherwise evaluated to determine the lift associated with additional touches. By incorporating exposure from other sources, systems and methods of the present disclosure are better suited for evaluating lift in an age where users may receive exposure from many different sources.

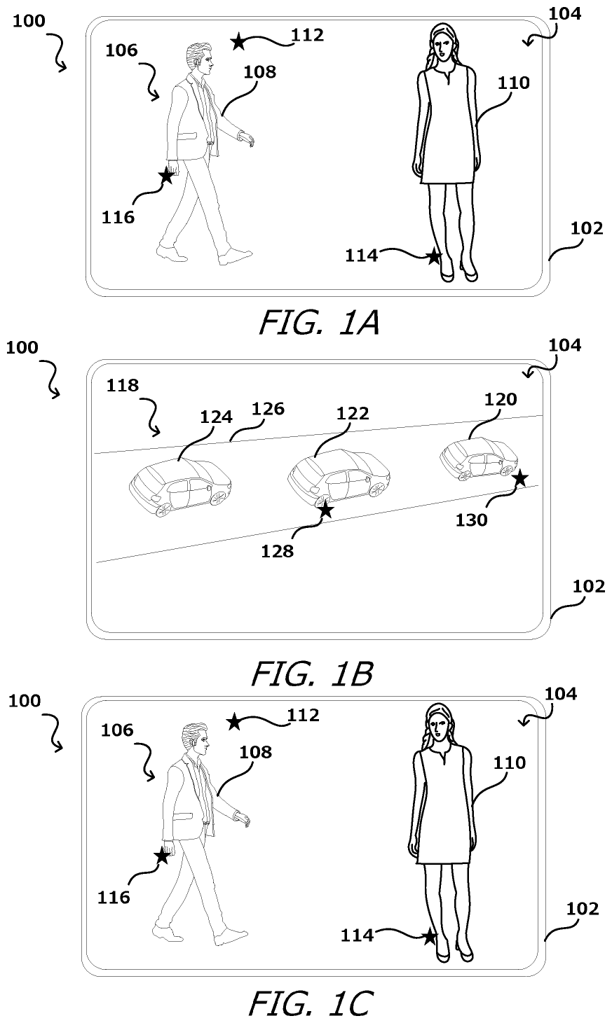

FIG. 1A illustrates an example environment 100 including a user device 102 having a display 104 that includes rendered content 106. It should be appreciated that, in various embodiments, the user device 102 may include one or more video processing components in order to render the content 106. However, in various embodiments, the content 106 may merely project or display content that is rendered by another device. The devices 102 can include, for example, portable computing device, notebook computers, ultrabooks, tablet computers, mobile phones, personal data assistants, video gaming consoles, televisions, set top boxes, smart televisions, portable media players, and wearable computers (e.g., smart watches, smart glasses, bracelets, etc.), display screens, displayless devices, other types of display-based devices, smart furniture, smart household devices, smart vehicles, smart transportation devices, and/or smart accessories, among others. The illustrated scene is a first person 108 walking toward a second person 110. However, it should be appreciated that the illustrated scene is by way of example only and the content may include any type of content, such as television programming, online videos, video games, audio playback, and the like. The rendered content 106 includes a plurality of characteristics 112, 114, 116 arranged at different locations. The characteristics 112, 114, 116 may include settings associated with the image/video scene, such as hue, color, luminosity, saturation, contrast, audio quality levels, and the like. As described above, the characteristics 112, 114, 116 may be utilized to generate a fingerprint for ACR to recognize and log the content being viewed by the user. As also described above, fingerprints may be generated from multiple scenes (e.g., at different points of the content playback) of the content, which may improve the accuracy of ACR. It should be appreciated that the characteristics 112, 114, 116 are for illustrative purposes only and may be located at different places in the scene. Alternatively, fingerprints may be embedded within the content and need not be generated from characteristics 112, 114, 116.

FIG. 1B illustrates the example environment 100 and the user device 102 having different rendered content 118 on the display 104. The illustrated different rendered content 118 may correspond to supplemental content. That is, content different than the media content originally consumed by the user. As shown in FIG. 1B, the different rendered content 118 is a commercial for an automobile, and shows three automobiles 120, 122, 124 travelling along a roadway 126. The different rendered content 118 also includes characteristics 128, 130 to facilitate identification of the content. As will be explained below, the identification of the different rendered content 118 may facilitate the determination that the user or household associated with the user device 102 has been exposed to the supplemental content. FIG. 1C illustrates the user device with the rendered content 106, which returns to the previously illustrated scene. The characteristics 112, 114, 116 are still associated with the rendered content 106 and may further be used to confirm the content on the display 104 and/or assign the user to a group, such as the exposed group.

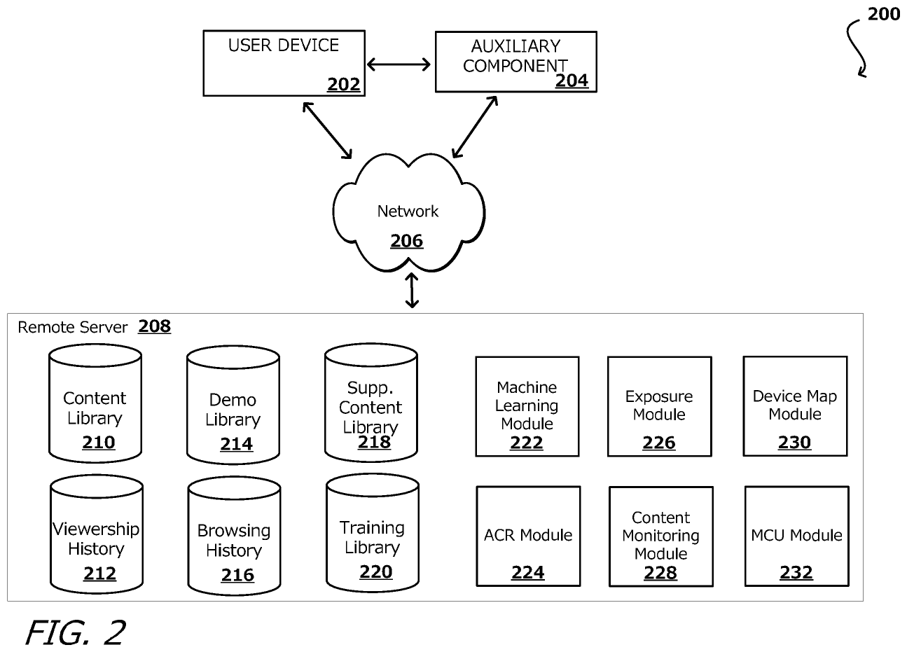

FIG. 2 illustrates an example system 200 for evaluating and determining exposures to certain types of content. In this example, the system 200 shows example data flows between a user device, a network, and associated components. It should be noted that additional services, providers, and/or components can be included in such a system, and although some of the services, providers, components, etc. are illustrated as being separate entities and/or components, the illustrated arrangement is provided as an example arrangement and other arranged as known to one skilled in the art are contemplated by the embodiments described herein. The illustrated system 200 includes the user device 202 and associated auxiliary components 204. As described above, the user device 202 may include a television, personal computing device, laptop, tablet computer, or any other type of device. Furthermore, the auxiliary components 204 may include surround sound speakers, sound bars, set top cable boxes, streaming service boxes, and the like. The illustrated embodiment, the user device 202 and/or the auxiliary components 204 may be in communication with a network 206. The network 206 may be configured to communicate with the user device 202 and/or the auxiliary components 204 via a wired or wireless connection. It should be appreciated that the network 206 may be an Internet or Intranet network that facilitates communication with various other components that may be accessible by the network 206.

The illustrated embodiment includes a remote sever 208, which may include a memory and processor for storing information and also executing written instructions, such as written instructions in a computer program. It should be appreciated that certain elements illustrated as associated with the remote server 208 may be arranged on a different server or memory bank. Further, the module and processes described may be executed by a hosting service, such as a “cloud” service, or by a virtualized server, rather than through dedicated servers or the like. The illustrated remote server 208 includes a content library 210. The content library 210 may include information regarding media content that may be consumed by the user via the user device 202. For example, the content library 210 may include information to enable the ACR techniques described above to identify content displayed on the user device 202. In various embodiments, the content library 210 includes content that may be from television broadcasts, set top boxes, streaming services, online videos, music services, video games, and the like. Furthermore, the content library 210 may be continuously updated and refined as new content is added to libraries, such as new series or video game releases.

In various embodiments, the remote server 208 further includes a viewership history database 212, which may be developed over a period of time by monitoring the content consumed via the user device 202, which may be facilitated through the use of the ACR techniques described above. The viewership history 212 may be on a household-by-household basis. That is, the viewership history 212 may be developed by evaluating content consumed that is associated with an IP addresses for a household or data access point. Additionally, in various embodiments, the viewership history 212 may be developed on a user-by-user basis (e.g., a user may sign into the user device 202) or on a device-by-device basis. Accordingly, the viewing habits of a user may be evaluated and saved within the database 212. For example, the viewership history 212 may include information directed to the specific content consumed (e.g., particular shows, movies, video games, etc.), the type of viewing (e.g., live, time-shifted, etc.), the source of the content (e.g., television antenna, cable services, satellite, streaming, etc.), temporal information (e.g., time of day, day of week, etc.), and the like. Accordingly, the viewing habits for households and the like may be tracked to determine whether the user is exposed to certain supplemental content, as will be described below.

The illustrated remote server 208 further includes a demographic library 214. The demographic library 214 may be directed toward the demographics of the household and/or user associated with the user device 202. For example, certain types of content, such as supplemental content, may be marketed differently based on demographics of the audience. Demographics may include age, gender, income, education, geographic location, and the like. By monitoring the demographics of the users associated with the user device 202, the supplemental content, and thereafter the synthetic exposures described herein, may be targeted to a very specific audience, thereby providing improved details to content providers. For example, a luxury car company may want to advertise to people having a certain income level and with a certain age bracket (e.g., older adults because teenagers would be unlikely to be able to purchase the vehicle). By knowing the demographics of the users, and the content they consume, supplemental content may be targeted to the media content consumed by the appropriate persons.

Additionally, in various embodiments, the remote server 208 includes a browsing history database 216. The browsing history database 216 may collect websites or other digital content accessed by the user, for example via a second user device. The browsing history may be correlated to an IP address, device identifier, cookies, supercookies, or other data or techniques which may allow secondary browsing to be tracked. For example, the browsing history may be utilized to monitor conversion events, such as navigating to a certain website after viewing supplemental content. Accordingly, conversions may be tracked on second screens and correlated to exposures from a different screen. The illustrated remote server 208 further includes a supplemental content library 218. In various embodiments, the supplemental content library 218 may be incorporated into the content library 210. In other embodiments, the supplemental content library 218 may include supplemental content, which may be identified by the fingerprints as described above. Furthermore, the supplemental content library 218 may include information to enable identification of product placement or other embedded supplemental content within other content. As a result, each exposure to supplemental content may be monitored.

In various embodiments, one or more machine learning techniques may be utilized in order to identify supplemental content or refine identification techniques. The illustrated embodiment includes a training library 220, which may be used to train machine learning techniques, such as neural networks, associated with the machine learning module 222. In various embodiments, the machine learning module 222 may obtain information from the remote server 208 or various other sources. The machine learning module 222 may include various types of models including machine learning models such as a neural network trained on the media content or previously identified fingerprints. Other types of machine learning models may be used, such as decision tree models, associated rule models, neural networks including deep neural networks, inductive learning models, support vector machines, clustering models, regression models, Bayesian networks, genetic models, various other supervise or unsupervised machine learning techniques, among others. The machine learning module 222 may include various other types of models, including various deterministic, nondeterministic, and probabilistic models. In various embodiments, the machine learning module 222 is utilized to quickly categorize and identify content associated with the extracted information. Further, the machine learning module 222 may be utilized to separate users between exposed and unexposed groups, and further to assist in identification of the control group described above. The neural network may be a regression model or a classification model. In the case of a regression model, the output of the neural network is a value on a continuous range of values, which may represent exposure, likelihood of exposure, or the like. In the case of a classification model, the output of the neural network is a classification into one or more discrete classes.

In various embodiments, an ACR module 224 is incorporated into the remote server 208 in order to facilitate generation and identification of fingerprints. It should be appreciated that at least a portion of the ACR module 224, or the entire module 224, may be integrated into the user device 202, as described above. As such, content may be recognized as it is distributed to the user device 202. The illustrated remote server 208 further includes an exposure module 226. The exposure module 226 may track or otherwise identify which supplemental content the users have been exposed to, based at least in part on their viewing history. For example, the exposure module 226 may collect data corresponding to what is classified as an exposure. In various embodiments, exposure may be defined as a period of time that the supplemental content is viewed. Additionally, a quantity of supplemental content viewed, whether the entire supplemental content was viewed, and the like may further be utilized to define what constitutes an exposure. The exposure module 226 may communicate with other portions of the remote server 208, such as the supplemental content library 218 and the ACR module 224, in order to identify supplemental content as they are presented on the user device 202 and further to monitor how the user reacts to the supplemental content. For example, the user fast forwarding through the supplemental content in an embodiment where the user is viewing the content in a time-shifted manner may not be classified as an exposure, based at least in part on the rules defined within the exposure module 226. Accordingly, the user's interaction with the supplemental content may be monitored. In various embodiments, the exposure module 226 may interact with a content monitoring module 228 in order to further monitor supplemental content. For example, the content monitoring module 228 may be utilized to monitor supplemental content or other exposures through secondary sources, such as a second screen via browsing history. This information may be transmitted to the exposure module 226 for processing. For example, users may be classified as exposed, even if they had not seen certain supplemental content during particular content, based on secondary interactions where an exposure event occurred. Accordingly, the remote sever 208 may be utilized to determine whether users have been exposed to certain supplemental content.

In various embodiments, a device map module 230 is further incorporated with the remote server 208, or another server in communication with at least one of the remote server 208 and/or the network 206. In various embodiments, the one or more user devices 202 and/or auxiliary components 204 may be associated with a device map or list of devices within a household associated with particular users. The device map module 230 determines the number of such user devices 202 and/or auxiliary components 204 that are active on the same network and/or in proximity to one another and use this information to estimate the number of individuals present and/or correlate user devices 202 to a device map. In various embodiments, the device map module 230 may have access to broader device map information including user device information for other households and thus may be able to determine that user devices 202 associated with other households are in proximity. In various embodiments, the device map module 230 may receive information regarding number of people in the room from an on-board camera within the television or from other devices within the room, for example a security camera that is configured to communicate with the device map module 230 over the network 206 or by determining a number of user devices 202 within the room. As a result, particularized exposures for a variety of users may be determined using the device map module 230.

As described above, in various embodiments one or more user devices 202 and/or auxiliary devices 204 may be associated with a device map and/or the illustrated device map module 230. In various embodiments, the user device 202 may be a television set. The user device 202 may be relatively stationary at a predetermined location, such as a user's home. However, other devices may move freely into and out of the home and around the user device 202. The device map may be used to determine a location of the other devices relative to the television set based on a number of factors, such as IP address, device IDs, cookies, NFC protocols, and the like. As a result, the device map may track relative locations of the other devices within the home, which may enable the determination of a number of users within a room interacting with the television set based at least in part on the device map module 230. In various embodiments, the device map module 230 may also determine information related to other devices not associated with the user, for example friends of the user, based on access to other device maps via the device map module 230. It should be appreciated that the device map module 230 may be associated with one or more machine learning modules, which may be the same machine learning modules discussed herein, to initiate rules or other evaluation to determine whether a user device is properly associated with a particular device map and user. As such, user devices associated with other households may be recognized, at least in part, to determine proximity and determination of a number of users within a room interacting with the television set. As described above, this may enable particularized identification of exposure events based on user devices, which may be correlated to other information, such as the demographic library 214 and/or browsing history 216 to track conversion events.

In various embodiments, an MCU module 232 may be utilized to separate users into groups based at least in part on exposure events, which may be tracked by the exposure module 226. For example, as described above, households and/or individual users may be broken down into at least three categories, although more or fewer may also be used. These categories may correspond to exposed users (EXP), which may correspond to users that have been exposed to supplemental content, where the exposure may be defined by various rules stored in the exposure module 226. Furthermore, users may be separated into a synthetic control group (SCG), which may correspond to users that have not been directed exposed to supplemental content, but that have one or more properties (e.g., demographic information, viewing habits, browsing habits, purchasing habits, etc.) that correspond to the EXP. As described above, synthetic exposures may be tracked for the SCG. Additionally, in various embodiments, the MCU may be determined, at least in part, by subtracting users that correspond to the SCG from a total number of unexposed users. It should be appreciated that the total number of unexposed users may be particularly selected based on a variety of factors, such as costs, processing times, demographic information, range of the supplemental content campaign, and the like. As a result, the MCU may be referred to as being at least part of a subset of the unexposed group. Similarly, the SCG may be a subset of the unexposed group. In other words, the SCG may be included within the unexposed group and utilized by the MCU. In various embodiments, the various subsets forming the MCU and the SCG may not overlap. That is, the MCU may not include members of the SCG, and vice versa. However, it should be appreciated that the subset forming the SCG may be included within the MCU. As will be described below, the MCU module 232 may further be utilized in order to randomly selected households from the EXP in order to establish conversion windows for comparison against the SCG and the EXP. Furthermore, in various embodiments, the MCU module 232 may enable comparison between the MCU+SCG and the EXP.

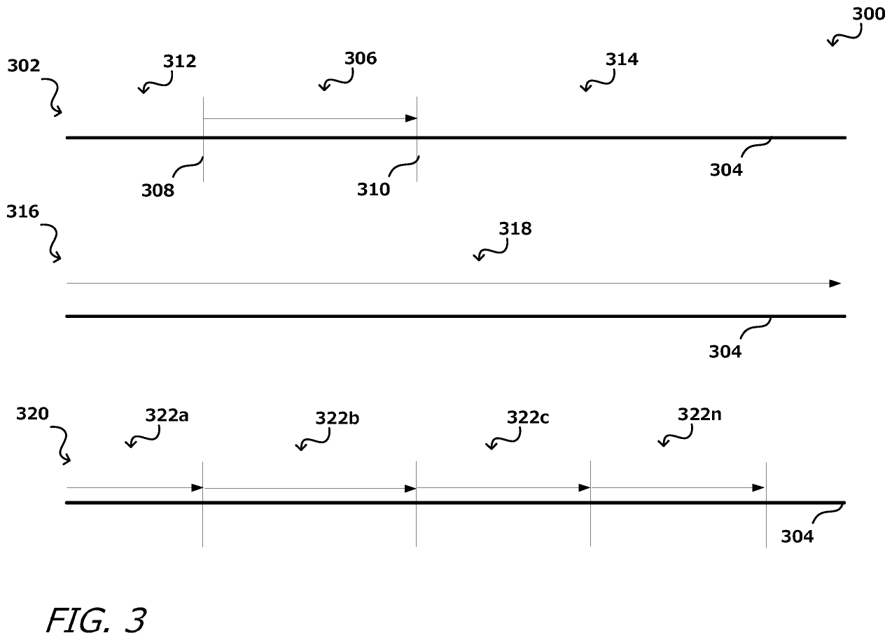

FIG. 3 illustrates a supplemental content campaign 300 having a plurality of different scenarios for tracking conversions. A first scenario 302 evaluates the campaign over a period of time 304 and defines a conversion window 306 between an exposure event 308 and an end time 310, which may be particularly established based on a variety of factors. By way of example, if the exposure event 308 occurs at 7 PM on a Monday and the conversion window 306 is defined as 3 days, the end time 310 will be 7 PM on Thursday. Accordingly, conversions that occur in a period of time before exposure 312 will not count, just as conversions that occur in a period of time after the end time 314 will not count. In this manner, the first scenario 302 may track conversions for groups exposed to supplemental content. Unfortunately, such tracking may have varying results based on the defined conversion window 306. For example, a user may not be “ready” or primed to purchase a product at the time they view the supplemental content, but the supplemental content may influence a later purchase. By way of example only, a household may be exposed to an advertisement for pizza on Monday night. However, the household may wait until Friday or Saturday night to convert and purchase the pizza because for that particular household, pizza may be an item that is reserved for the weekends. Accordingly, a conversion event that may be attributed to the supplemental content would not be counted if the conversion window 306 were not long enough. Such a scenario may be utilized when tracking conversions for EXP and SCG, and as a result, may not provide a realistic comparison when evaluated against another unexposed group, as will be described below.

A second scenario 316 illustrates the campaign over the period of time 304 without an exposure event 308 or end time 310. That is, the entire period of time 304 counts as a conversion window 318. In various embodiments, this may lead to misleading information, because the conversion window 318 being equal to the period of time 304 may be substantially longer than other conversion windows associated with exposure events, for example conversion window 316 illustrated with respect to the first scenario 302. As a result, information related to unexposed users may not be directly correlated to that of EXP or SCG because the comparisons are not normalized over equivalent periods of time.

A third scenario 320 illustrates the campaign over the period of time 304 having a plurality of predetermined conversion windows 322a-n. In the third scenario 320, one or more predetermined conversion windows 322a-n may be utilized to track conversions for unexposed groups. In various embodiments, the conversion windows 322a-n may correspond in length to the conversion window 306, however, they may not accurately reflect the timing of real supplemental content exposures. Accordingly, comparisons utilizing this information will also be inaccurate when evaluating a difference between conversions for EXP, SCG, and unexposed groups. As will be described below, in various embodiments MCU may be utilized to correlate exposure events to conversion windows for unexposed groups, thereby identifying which conversion events should be attributed to conversions.

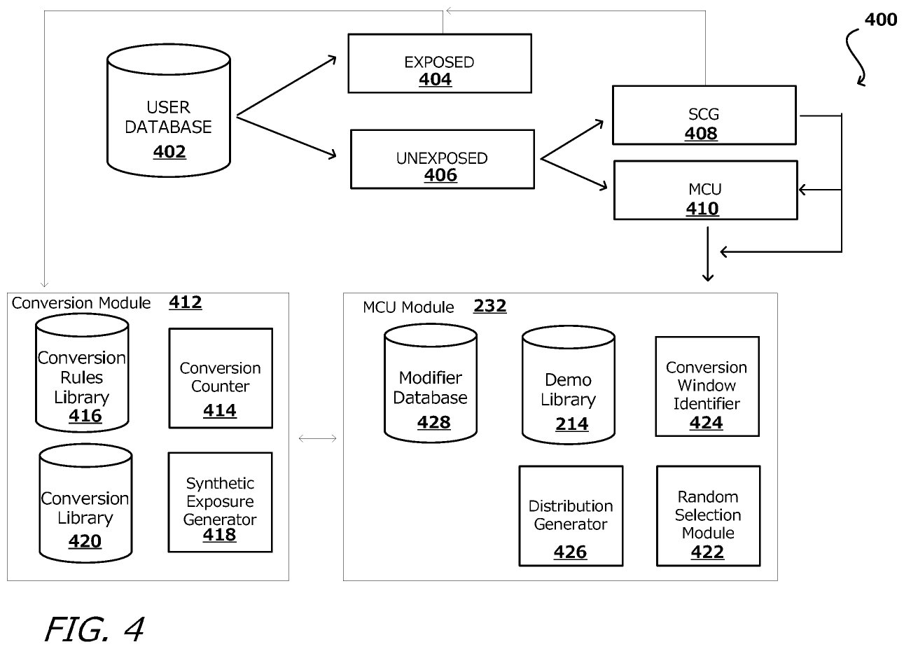

FIG. 4 illustrates an example system 400 for classifying users between exposed and unexposed categories and tracking conversions for the classified users. As used herein, exposed, which may be referred to as EXP, may refer to users that have interacted with or otherwise viewed supplemental content for a predetermined period of time. That period of time may be adjusted based on the supplemental content. For example, supplemental content that only lasts for 5 seconds may require a greater percentage of the supplemental content being viewed (e.g., 80 percent or 100%) compared to a longer, multi-minute supplemental content. Additionally, other types of interactions may be incorporated to define exposure, such as a user clicking on a link or utilizing another feature associated with the supplemental content. Furthermore, in various embodiments the supplemental content may be directed toward product placement or other more subtle forms, and as a result, multiple touches or exposures may be tallied in order to determine whether the user has been exposed to the supplemental content. As used herein, unexposed may refer to users that have not interacted with or otherwise viewed supplemental content. In various embodiments, users that are unexposed may be the users that are not part of the exposed category. However, different sets of rules or criteria may be established for unexposed users.

In the illustrated embodiment, the system 400 includes a user database 402, which may be a collection of users utilizing the service or a subset of those users. For example, the user database 402 may include each user that participates within the system to enable ACR within their user devices. However, because many supplemental content rollouts may be regional or targeted, the user database 402 may also be a subset (which is likely smaller than the total number of users) directed to users based on a predetermined criterion or multiple criteria. As illustrated, the users may be divided into categories, such as the illustrated exposed group 404 and the unexposed group 406. Accordingly, the subsequent conversion rates of these users may be evaluated separately and independently, which will provide a refined determination of the lift associated with the supplemental content. For example, the conversion rate of the users in the exposed group 404 may be compared to the conversion rate for the users in the unexposed group 406. If the conversion rates are substantially similar, it may be determined that the lift of the campaign was low. In other words, the supplemental content may have been ineffective. However, if the conversion rates are different, then it is likely that the difference may be attributed to the supplemental content. Furthermore, in various embodiments the conversion rate for the general population may be further evaluated. Thereafter, comparing the three conversion rates may provide an improved metric to evaluate lift. For example, the difference between the conversion rate for the exposed group and the conversion rate for the unexposed group may be more significant when evaluating lift than by looking at the difference between the conversion rate of the exposed group and the general population. As such, lift may be determined by looking at the conversion rates of targeted, specific groups of users.

The illustrated embodiment further includes a synthetic control group (SCG) 408, which is a subset of the unexposed group 406. The SCG 408 includes users that were not exposed to the supplemental content, but that had a likelihood of being exposed based at least in part on their prior viewership history. For example, SCG 408 may include users who watch a particular program regularly, but who may have missed a particular episode during which the supplemental content was deployed. Furthermore, in various embodiments, the SCG 408 may include users that would likely enjoy a certain type of programming or particular program based on their prior history. For example, a different program may be produced by the same production company, include the same actors, have the same writers, or the like, as another program that has been watched by a user. Accordingly, it may be inferred that the users may share at least some characteristics due to their similar tastes in content, and therefore these users may be evaluated as a group that may be likely to lead to some conversion event, even without direct exposure to the supplemental content. As will be described below, the SCG 408 may be derived from a machine learning based analysis of the likelihood of a viewer being exposed to supplemental content.

In various embodiments, a further subset of the unexposed group 406 is the MCU 410, as described above. In the illustrated embodiment, the MCU 410 is separate and distinct from the SCG 408. That is, users that fall within the SCG 408 do not fall within the MCU 410, and vice versa. However, it should be appreciated that, in other embodiments, users may be categorized into both the SCG 408 and the MCU 410. Accordingly, in various embodiments, the SCG 408 may be utilized by the MCU module 232, as illustrated by the arrow. Moreover, in embodiments, the SCG may be merged with the MCU 410 for use by the MCU module 232.

In various embodiments, a conversion module 412 is utilized to measure conversion rates for the different groups, for example the EXP 404 and the SCG 408. However, as described above, it should be appreciated that, in various embodiments, the SCG 408 is part of the unexposed group 406 that is utilized by the MCU module 232 and may not be utilized by the conversion module 412. In various embodiments, different modules or features may be illustrated as separate, but may be integrated into single components. The conversion module 412 includes a conversion counter 414, which may record conversion occurrences, such as clicks on a link or purchases. In various embodiments, the conversion counter 414 receives information from other sources to track conversion events for users. For example, the browsing history database 216, as described above, may track online or other activity for a user or household, which may be based on an IP address, device identifier, cookie, or the like. Accordingly, after exposure to supplemental content, the user's browsing history may be monitored for conversion events for a predetermined period of time. Various definitions for actions that constitute what a conversion is may be stored in a conversion rules library 416. For example, the conversion window may be stored in the conversion rules library 416. Furthermore, for some content providers a conversion may be navigating to a website. For others, a conversion may be purchasing product or watching a different television program. Accordingly, these definitions may be referenced by the conversion counter 414 when determining whether or not a conversion has occurred. As a result, a conversion rate for supplemental content may be determined by calculating the number of conversions per number of exposed users. In this manner, content providers can measure the success of their supplemental content.

In various embodiments, the conversion module 412 tracks conversion rates for unexposed users/households and/or generates synthetic exposure events. For example, a synthetic exposure generator 418 may develop and deploy synthetic exposure events to unexposed users of the SCG 408. The events may be related to the group's viewership scores and/or viewership history. Furthermore, the events may be related to demographic information for the consumers. Accordingly, the synthetic exposure generator 418 enables a direct comparison, over a predetermined period of time, for conversions between the EXP 404 and the SCG 408. For example, the control group may be selected and a date or range of dates may be selected as the synthetic exposure. Thereafter, the user's activity may be tracked, via the conversion counter 414, to determine whether a conversion takes place, even without exposure to the supplemental content. As such, the determined conversion rate may be compared to the conversion rate associated with the exposed group. The difference between the conversion rates may more accurately reflect the lift from the supplemental content because it would evaluate whether similar users would convert in the absence of viewing the supplemental content.

In various embodiments, the conversion module 412 further includes a conversion library 420, which stores conversions and/or conversion rates for the various groups. As will be described below, the conversion library 420 may be utilized by the MCU module 232 for establishing appropriate attribution for the MCU 410. That is, the conversion library 420 may be used to define conversion windows and the like for the MCU 410.

In various embodiments, the MCU module 232 receives information from the MCU 410 in order to determine a conversion rate for the MCU 410. For example, information about the users and/or households in the MCU 410 may be transmitted to the MCU module 232 for analysis. The MCU module 232 includes a random selection module 422. In various embodiments, the random selection module 422 accesses the conversion library 420 and randomly selects one or more households from the EXP 404. It should be appreciated that random may describe pseudorandom numbers, for example numbers procedurally generated by a computer program, and is not intended to limit the disclosure to truly random selection. Once the random selection module 422 selects the one or more households, the conversion window identifier 424 may access the conversion rules library 416 to determine the conversion window utilized for the selected one or more households. The conversion window identifier 424 thereafter applies the identified conversion window to the MCU 410 and the conversion counter 414 tracks conversions over the conversion window. As a result, conversions between the EXP 404 and the MCU 410 are evaluated over the same period of time, providing a more accurate comparison of the impact of the campaign.

The illustrated MCU module 232 further includes a distribution generator 426. It should be appreciated that the random selection module 422 may be utilized over any number of households so that a large variety of different conversion windows may be evaluated. Accordingly, the importance of an outlier may be reduced. The distribution generator 426 develops a distribution of conversions over a variety of conversion windows to develop an average conversion for the MCU 410. Accordingly, the average conversion related to the campaign may be evaluated for the MCU 410, even without any exposure events. Evaluations of campaigns may not take into account the general likelihood of a conversion even without any exposure event at all. It should be appreciated that, in various embodiments, the conversion windows utilized in evaluating the MCU 410 may be taken from the EXP 404, the SCG 408, or a combination thereof. Additionally, the EXP 404 and the SCG 408 may be weighted differently based on one or more factors.

In various embodiments, the MCU 410 further includes, or has access to, the demographic library 214. As a result, different campaigns may be filtered for different demographic groups, thereby providing more precise information. Additionally, the illustrated MCU module 232 also includes a modifier database 428. In various embodiments, the modifier database 428 includes information that corresponds to one or more events that may impact a campaign. For example, the modifier database 428 may include information related to the weather when a campaign was ongoing. By way of example, more users may be indoors with a greater likelihood of exposure to content during certain weather events, such as rain storms or very cold temperatures. Additionally, holidays may impact the campaigns as well, such as large family-gathering holidays such as Thanksgiving providing greater numbers of exposure to users that may not be in their home towns. That is, a user may travel away from their home town and see an ad for a local business. It is unlikely such an exposure will lead to a conversion because the user may only be visiting for a short period of time. Accordingly, the modifier database 428 may factor in events such as weather, holidays, large sporting events (e.g., Super Bowl, World Cup, etc.), season, and the like in order to filter and adjust information to further evaluate conversion rates with the conversion module 412.

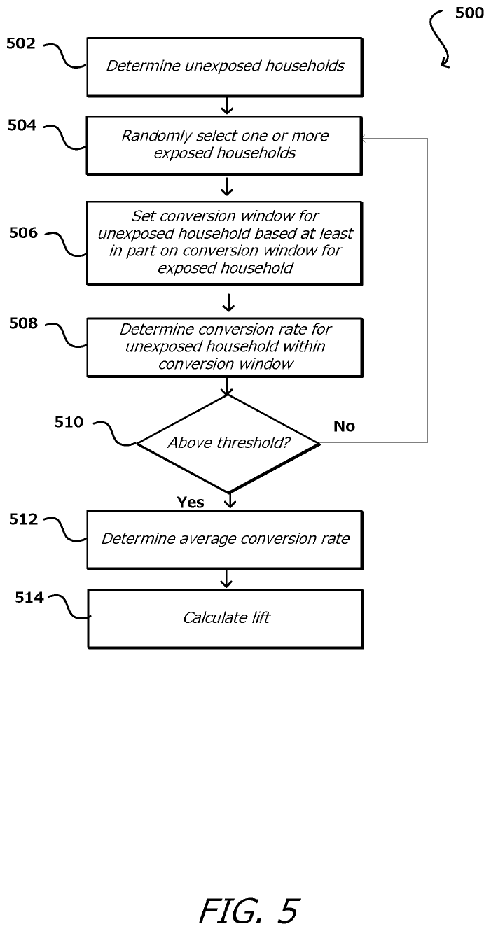

FIG. 5 is a flow chart representing a method 500 for calculating lift for a secondary content campaign. It should be understood that, for any process discussed herein, there can be additional, fewer, or alternative steps performed in similar or alternative orders, or in parallel, within the scope of the various embodiments. The method begins by determining unexposed households from a database of users 502, for example the user database 402. In various embodiments, the unexposed households may correspond to the households that have not had one or more users be exposed to supplemental content corresponding to a campaign. As described above, exposure may be particularly selected for a given campaign, for example based on duration the supplemental content is watched, time the supplemental content is viewed, and the like. In various embodiments, the unexposed households may be subdivided into different categories, such as the above-described SCG and the MCU. In various embodiments, the MCU correspond to the users that are unexposed and not part of the SCG. Furthermore, in embodiments, the SCG is included as part of the unexposed users within the MCU.

The method may continue by randomly selecting one or more households from an exposed group 504. As described above, the exposed group may correspond to households where one or more users have been exposed to the supplemental content. In various embodiments, the selection may not be truly random. The exposed households may have gone on to convert based on the exposure event or may not. A conversion window may be set 506 based at least in part on the conversion window of the selected exposed household. For example, the conversion window may equal the conversion window for the exposed household, which may be defined by one or more rules, as described above.

In various embodiments, a conversion rate for the unexposed household, within the set conversion window is determined 508. For example, information such as online browsing or purchase history may be evaluated for the unexposed households within the conversion window. If a conversion event occurs, which may be particularly defined for different campaigns, the conversion may be recorded. Because a particular unexposed household or conversion window may be an outlier, a number of different random households may be selected and evaluated against the unexposed households. In other words, a plurality of conversion windows may be evaluated. In various embodiments, the number of evaluations is compared against a threshold 510. The threshold may correspond to a number of random samples that are taken to evaluate whether conversion rates converge. In other words, as the conversion rate stabilizes to a particular value, it may be determined that a sufficient number of random samples are used. For example, the threshold may be experimentally determined by evaluating different numbers of random samples to determine how many provide sufficient convergence. It should be appreciated that, while more samples may be desirable, it may be computationally problematic to evaluate too many samples. As a result, the threshold may be tied to the convergence of conversion rates as more samples are added. In this manner, a minimum number of samples may be determined and defined as the threshold for a particular campaign or a range of campaigns. It should be appreciated that the threshold may be different for different types of campaigns or for differently defined conversion events. If the number does not exceed the threshold, additional random households are selected. If the number exceeds the threshold, an average conversion rate is determined 512. Because conversion rates are being compared at the same time as real exposures, a distribution may be generated to see how real exposure events can be attributed to conversions. That is, the timing of the exposures will reflect real exposures within the exposed group. From there, the lift may be calculated 514. For example, the conversion rate for the exposed group may be compared to the conversion rate for the unexposed group. In various embodiments, further conversion rates such as the SCG conversion rate may also be utilized to calculate the lift.

As described above, the lift of the campaign represents the amount that conversions may be attributed to the campaign. In other words, lift may refer to the effectiveness of a campaign. In various embodiments, lift may be highest closest to an exposure event and then decrease over time. As a result, some campaigns may utilize “touches” where multiple exposure events occur over a period of time, which may effectively reset conversion windows for evaluation. While exposure may be the driving force behind a conversion, as described above in various embodiments certain users with a higher propensity to convert may be identified, for example based on demographic information, which may be described as the SCG. Using SCG, a more accurate idea of lift may be evaluated. For example, the EXP may have a conversion rate EXP_{CON} that corresponds to the conversion rate for the EXP over the period of the campaign, over a certain conversion window, or the like. Additionally, as described above, the SCG may have a conversion rate SCG_{CON} that is indicative of the rate at which users with similar demographics may convert, even without being exposed to the supplemental content. Accordingly, the effect of a campaign on a targeted audience may be represented by EXP_{CON}-SCG_{CON}.

However, such an evaluation does not describe a full picture of the total lift associated with the campaign. For example, as described above, evaluating conversions with respect to the MCU may enable a determination of the total effect of targeting a campaign. For example, the MCU may have a conversion rate MCU_{CON} that corresponds to the average conversion rate that may be calculated via the MCU module 232. By comparing the MCU_{CON} to the SCG_{CON}, the propensity of the targeted audience to convert without seeing the ad may be determined, which may be represented by SCG_{CON}-MCU_{CON}. Furthermore, the total effect of the targeting may be determined by EXP_{CON}-MCU_{CON}. As a result, the lift for the campaign may be evaluated with respect to the SCG and the MCU, which provides a more accurate representation of how much conversion to attribute to the campaign.

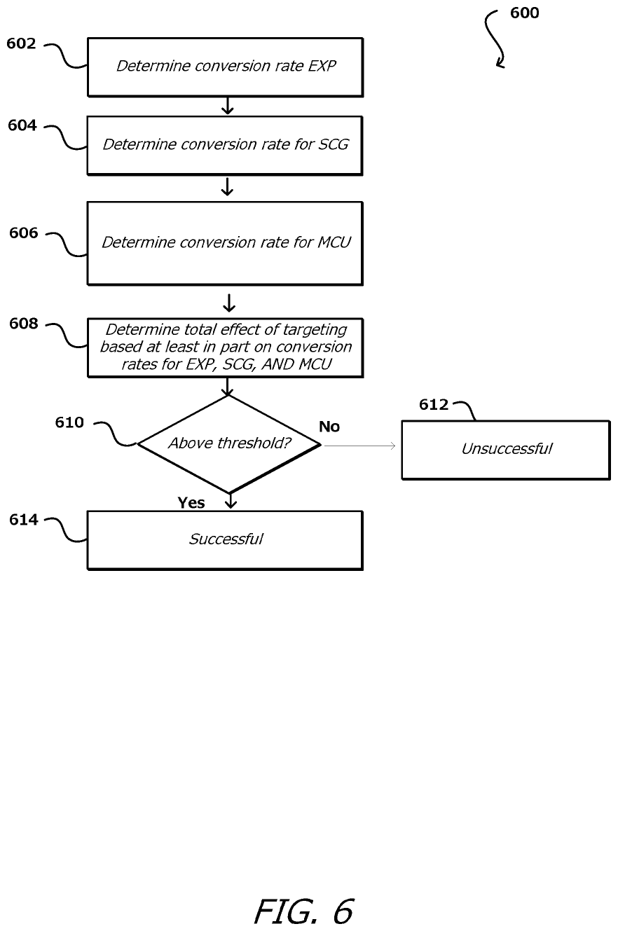

FIG. 6 is a flow chart representing a method 600 for determining lift for a campaign. The method 600 includes determining a conversion rate for the EXP 602. Conversion rate may be determined by any of the methods described herein, such as monitoring a user's browsing or purchase history after an exposure event has occurred. Additionally, the method may include determining a conversion rate for the SCG 604, for example as described above. Additionally, the conversion rate for the MCU is determined 606. The various conversion rates may be evaluated to determine the effect of targeting the campaign 608. For example, the SCG conversion rate may be subtracted from the EXP conversion rate to determine the effect of the campaign on a targeted audience. Additionally, the MCU conversion rate may be subtracted from the SCG conversion rate to determine the propensity of the targeted audience to convert without exposure to ads. Furthermore, in various embodiments, the total effect of targeting may be determined by subtracting the MCU conversion rate from the EXP conversion rate. The effect may be evaluated against a threshold 610. If the effect is below the threshold, the campaign may be deemed unsuccessful 612. If the effect is above the threshold, the campaign may be deemed successful 614. Accordingly, information regarding the success of various campaigns may be utilized in future campaigns to either improve targeting or to update strategies for increasing conversions.

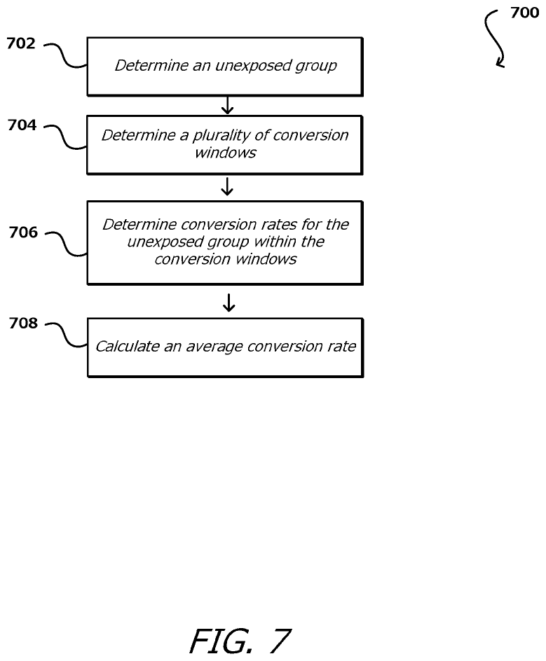

FIG. 7 is a flow chart representing a method 700 for calculating an average conversion rate. The method includes determining an unexposed group 702. In various embodiments, the unexposed group is the MCU, which corresponds to households that have not been exposed to supplemental content sufficient to establish an exposure event. In various embodiments, the MCU is not part of the SCG, however in other embodiments there may be overlap. That is, households within the SCG are included in the MCU because households in the SCG may form at least a subset of the unexposed group. Next, a plurality of conversion windows may be established 704. For example, an exposed group (e.g., EXP), may be evaluated to determine a plurality of conversion windows based on exposures to supplemental content. These conversion windows may be utilized to determine conversion rates for the unexposed group 706. As a result, the conversions between the exposed group and the unexposed group are evaluated over the same period of time, which may provide an improved correlation to the lift of the campaign. Thereafter, an average conversion rate may be calculated 708. This after conversion rate may represent a distribution over conversion rates over a wide range of conversion windows. The average may be associated with the exposed group or the unexposed group.

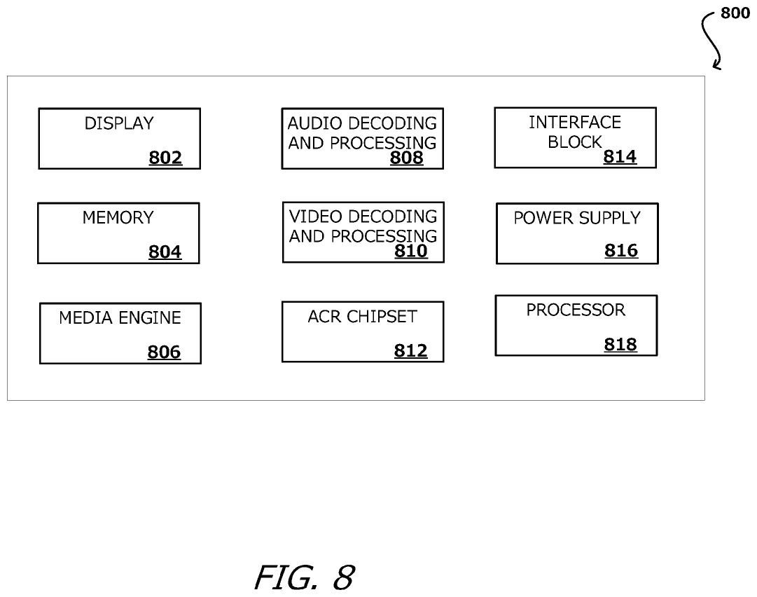

FIG. 8 illustrates an example user device 800, which may include display elements (e.g., display screens or projectors) for displaying consumer content. In various embodiments, the user device 800 may be a television, smartphone, computer, or the like as described in detail above. In various embodiments, the illustrated user device 800 includes a display 802. As will be appreciated, the display may enable the viewing of content on the user device 800. The display may be of a variety of types, such as liquid crystal, light emitting diode, plasma, electroluminescent, organic light emitting diode, quantum dot light emitting diodes, electronic paper, active-matrix organic light-emitting diode, and the like. The user device 800 further includes a memory 804. As would be apparent to one of ordinary skill in the art, the device can include many types of memory, data storage, or computer-readable media, such as a first data storage for program instructions for execution by the at least one processor.

In various embodiments, the user device 800 includes a media engine 806. As used herein, the media engine 806 may include an integrated chipset or stored code to enable the application of various media via the user device 800. For example, the media engine 806 may include a user interface that the user interacts with when operating the user device 800. Further, the media interface 806 may enable interaction with various programs or applications, which may be stored on the memory 804. For example, the memory 804 may include various third-party applications or programs that facilitate content delivery and display via the user device 800.

In various embodiments, the user device 800 further includes an audio decoding and processing module 808. The audio decoding and processing module 808 may further include speakers or other devices to project sound associated with the content displayed via the user device 800. Audio processing may include various processing features to enhance or otherwise adjust the user's auditory experience with the user device 800. For example, the audio processing may include features such as surround-sound virtualization, bass enhancements, and the like. It should be appreciated that the audio decoding and processing module 808 may include various amplifiers, switches, transistors, and the like in order to control audio output. Users may be able to interact with the audio decoding and processing module 808 to manually make adjustments, such as increasing volume.

The illustrated embodiment further includes the video decoding and processing module 810. In various embodiments, the video decoding and processing module 810 includes components and algorithms to support multiple ATSC DTV formats, NTSC and PAL decoding, various inputs such as HDMI, composite, and S-Video inputs, and 2D adaptive filtering. Further, high definition and 3D adaptive filtering may also be supported via the video decoding and processing module 810. The video decoding and processing module 810 may include various performance characteristics, such as synchronization, blanking, and hosting of CPU interrupt and programmable logic I/O signals. Furthermore, the video decoding and processing module 810 may support input from a variety of high definition inputs, such as High Definition Media Interface and also receive information from streaming services, which may be distributed via an Internet network.

As described above, the illustrated user device 800 includes the ACR chipset 812, which enables an integrated ACR service to operate within the user device 800. In various embodiments, the ACR chipset 812 enables identification of content displayed on the user device 800 by video, audio, or watermark cues that are matched to a source database for reference and verification. In various embodiments, the ACR chipset 812 may include fingerprinting to facilitate content matching. The illustrated interface block 814 may include a variety of audio and/or video inputs, such as via a High Definition Media Interface, DVI, S-Video, VGA, or the like. Additionally, the interface block 814 may include a wired or wireless Internet receiver. In various embodiments, the user device 800 further includes a power supply 816, which may include a receiver for power from an electrical outlet, a battery pack, various converters, and the like. The user device 800 further includes a processor 818 for executing instructions that can be stored on the memory 804.

The specification and drawings are, accordingly, to be regarded in an illustrative rather than a restrictive sense. It will, however, be evident that various modifications and changes may be made thereunto without departing from the broader spirit and scope of the invention as set forth in the claims.

What is claimed is:

1. A method, comprising:
receiving exposure data for a set of households, the exposure data comprising supplemental content associated with media content;
determining an exposed set of households from the set of households, the exposed set of households corresponding to households of the set of households that have been exposed to the supplemental content, the exposures occurring within a first set of conversion windows;
determining an unexposed set of households from the set of households, the unexposed set of household corresponding to households of the set of households that have not been exposed to the supplemental content;
determining a second set of conversion windows for the unexposed households, the second set of conversion windows being based at least partially on the first set of conversion windows; and
determining a conversion rate for the unexposed households within the second set of conversion windows, the conversion rate associated with interactions related to the supplemental content within the second set of conversion windows.

2. The method of claim 1, further comprising:
comparing a number of the exposed set of households to a threshold;
obtaining a third set of conversion windows corresponding to a second exposed set of households when the number of exposed set of households is below the threshold; and
determining a second conversion rate for the unexposed households within the third set of conversion windows.

3. The method of claim 1, further comprising:
determining an exposed conversion rate for the exposed set of households;
comparing the exposed conversion rate for the exposed set of households to the conversion rate for the unexposed households; and
determining a lift associated with the supplemental content based at least in part on a difference between the exposed conversion rate for the exposed set of households and the conversion rate for the unexposed households.

4. The method of claim 1, further comprising:
determining a second unexposed set of households from the set of households, the second unexposed set of households corresponding to households of the set that have not been exposed to the supplemental content;
forming a control group from the second unexposed set of households, the control group corresponding to households having a likelihood above an exposure threshold for exposure to the supplemental content; and
determining a conversion rate for the control group within a control conversion window.

5. The method of claim 4, further comprising:
determining an exposed conversion rate for the exposed set of households;
comparing the exposed conversion rate for the exposed set of households to the conversion rate for the unexposed households; and
determining a lift associated with the supplemental content based at least in part on a difference between the exposed conversion rate for the exposed set of households, the conversion rate for the control group, and the conversion rate for the unexposed households.

6. The method of claim 1, wherein the second set of conversion windows is equal to the first set of conversion windows.

7. A computing device, comprising:
a microprocessor; and
memory including instructions that, when executed by the microprocessor, cause the computing device to:
obtain viewership data corresponding to content consumed by a plurality of households, the content including supplemental content;
determine a group of exposed households from the plurality of households, the exposed households having a minimum interaction with the supplemental content;
determine a set of conversion windows comprising a respective conversion window for each exposed household of the group of exposed households, the respective conversion window defining a period of time associating the minimum interaction with the supplemental control to the exposure;
determine a group of unexposed households from the plurality of households;
set at least one conversion window of the set of conversion windows as an unexposed conversion window for an unexposed household of the group of unexposed households; and
determine an unexposed conversion rate for the unexposed household within the unexposed conversion window.

8. The computing device of claim 7, wherein the memory includes instructions that, when executed by the microprocessor, further cause the computing device to:
determine a second unexposed conversion rate for the unexposed household within a second unexposed conversion window, different from the unexposed conversion window; and
determine an average unexposed conversion rate.

9. The computing device of claim 7, wherein the memory includes instructions that, when executed by the microprocessor, further cause the computing device to:
determine a second group of unexposed households from the plurality of households, the second group of unexposed households having at least one demographic property representative of an increased likelihood of exposure to the supplemental content;
set a second conversion window for the second group of unexposed households; and
determine a second unexposed conversion rate for the second group of unexposed households.

10. The computing device of claim 9, wherein the memory includes instructions that, when executed by the microprocessor, further cause the computing device to:
determine an exposed conversion rate for the exposed households within the conversion window;
determine a lift associated with the supplemental content, the lift corresponding to a difference between the exposed conversion rate, the second unexposed conversion rate and unexposed conversion rate.

11. The computing device of claim 7, wherein the memory includes instructions that, when executed by the microprocessor, further cause the computing device to:
determine a conversion distribution over at least a portion of the exposed households, the conversion distribution corresponding to the exposed conversion rate over a plurality of different conversion windows.

12. The computing device of claim 7, wherein the memory includes instructions that, when executed by the microprocessor, further cause the computing device to:
obtain a browsing history for each household of the group of unexposed households, wherein the conversion rate for the unexposed households is calculated based at least in part on the browsing history.

13. A method, comprising:
obtaining viewership data corresponding to content consumed by a plurality of households, the content including supplemental content;
determining a group of exposed households from the plurality of households, the exposed households having a minimum interaction with the supplemental content;
determining a set of conversion windows comprising a respective conversion window for each exposed household of the group of exposed households, the respective conversion window defining a period of time associating the minimum interaction with the supplemental control to the exposure;
determining a group of unexposed households from the plurality of households;
setting at least one conversion window of the set of conversion windows as an unexposed conversion window for an unexposed household of the group of unexposed households; and
determining an unexposed conversion rate for the unexposed household within the unexposed conversion window.

14. The method of claim 13, further comprising:
determining a second unexposed conversion rate for the unexposed household within a second unexposed conversion window, different from the unexposed conversion window; and
determine an average unexposed conversion rate based at least in part on the unexposed conversion rate and the second unexposed conversion rate.

15. The method of claim 13, further comprising:
determining an average exposed conversion rate as a function of days after exposure for at least one household of the exposed households;
determining an average unexposed conversion rate as a function of days after exposure for at least one household of the unexposed households;
comparing the average exposed conversion rate to the average unexposed conversion rate; and
recalculating the average exposed conversion rate and the average unexposed conversion rate when the conversion rate is lower at an end of a campaign than at a beginning of the campaign.

16. The method of claim 13, further comprising:
determining a second group of unexposed households from the plurality of households, the second group of unexposed households having at least one demographic property representative of an increased likelihood of exposure to the supplemental content;
setting a second conversion window for the second group of unexposed households;
determining a second unexposed conversion rate for the second group of unexposed household;
comparing the second unexposed conversion rate to the unexposed conversion rate; and
determining a level of success of a campaign based at least in part on the comparison between the second unexposed conversion rate and the unexposed conversion rate.

17. The method of claim 13, further comprising:
determining a conversion distribution over at least a portion of the exposed households, the conversion distribution corresponding to the exposed conversion rate over a plurality of different conversion windows.

18. The method of claim 13, further comprising:
determining a targeting lift based at least in part on a difference between the exposed conversion rate and the unexposed conversion rate.

19. The method of claim 18, further comprising:
adjusting a campaign based at least in part on the targeting lift, wherein a campaign length is increased when the targeting lift is above a threshold.

20. The method of claim 13, further comprising:
obtaining a browsing history for each household of the group of unexposed households, wherein the conversion rate for the unexposed households is calculated based at least in part on the browsing history.
